(19) United States
(12) Patent Application Publication
(10) Pub. No.: US 2025/0229783 A1
(43) Pub. Date: Jul. 17, 2025

(54) Systems and Method for Tire Road Limit Nearness Estimation

(71) Applicant: GM Cruise Holdings LLC, San Francisco, CA (US)

(72) Inventors: Shad Laws, Redwood City, CA (US); Martin Sehr, Kensington, CA (US)

(21) Appl. No.: 18/730,768

(22) PCT Filed: Nov. 21, 2022
(86) PCT No.: PCT/US22/50644

§ 371 Date: Jul. 20, 2024

Related U.S. Application Data
(60) Provisional application No. 63/301,880, filed on Jan. 21, 2022.

(51) Int. Cl. B60W 30/18; B60W 30/02; B60W 50/00

(52) U.S. Cl. CPC B60W 30/18172; B60W 30/02; B60W 50/0098; B60W 2520/125; B60W 2520/26; B60W 2552/40

(57) ABSTRACT

For one embodiment of the present invention, a computer implemented method of determining tire road limit nearness estimation is described. The computer implemented method includes obtaining sensor signals from a sensor system of a vehicle to monitor driving operations and to determine localization of the vehicle. The method further includes determining lateral force disturbances for front and rear lateral accelerations and a bulk longitudinal force disturbance for the vehicle based on the localization and the sensor signals and determining a tire road limit nearness estimation for the vehicle based on the sensor signals, the lateral force disturbances for front and rear lateral accelerations and the bulk longitudinal force disturbance.

### CROSS-REFERENCE TO RELATED APPLICATIONS

This application claims the benefit of U.S. Provisional Patent Application No. 63/301,880, entitled “Systems and Method For Tire Road Limit Nearness Estimation”, filed on Jan. 21, 2022, the contents of which are incorporated herein by reference in their entirety and for all purposes.

### TECHNICAL FIELD

Embodiments described herein generally relate to the fields of vehicles having driver assistance and autonomous vehicles, and more particularly relates to vehicle systems and a method for tire road limit nearness estimation.

### BACKGROUND

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The vehicles can be used to pick up passengers and drive the passengers to selected destinations. The vehicles can also be used to pick up packages and/or other goods and deliver the packages and/or goods to selected destinations.

### SUMMARY

For one embodiment of the present invention, a computer implemented method of determining tire road limit nearness estimation is described. The computer implemented method includes obtaining sensor signals from a sensor system of a vehicle to monitor driving operations and to determine localization of the vehicle. The computer implemented method further includes determining lateral force disturbances for front and rear lateral accelerations and a bulk longitudinal force disturbance for the vehicle based on the localization and the sensor signals. The computer implemented method further includes determining a tire road limit nearness estimation for the vehicle based on the sensor signals, the lateral force disturbances for front and rear lateral accelerations and the bulk longitudinal force disturbance.

Other features and advantages of embodiments of the present invention will be apparent from the accompanying drawings and from the detailed description that follows below.

### BRIEF DESCRIPTION OF THE DRAWINGS

FIG. 1 illustrates an autonomous vehicle and remote computing system architecture in accordance with some examples of the present disclosure.

FIG. 2 illustrates an exemplary autonomous vehicle 200 in accordance with some examples of the present disclosure.

FIGS. 3A and 3B illustrate a computer-implemented method for determining a tire road limit nearness estimation based on sensor signals from a sensor system and lateral and longitudinal force disturbance signals in accordance with some examples of the present disclosure.

FIG. 4 illustrates a tire force versus slip angle diagram in accordance with some examples of the present disclosure.

FIG. 5 illustrates a diagram of a vehicle having driver assistance according to some examples of the present disclosure.

FIG. 6 illustrates a block diagram of a control system for dynamic modeling of a vehicle in accordance with some examples of the present disclosure.

FIG. 7 illustrates longitudinal acceleration versus lateral acceleration of a vehicle in accordance with some examples of the present disclosure.

FIG. 8 illustrates a tire force versus tire slip angle diagram with a linear handling region and a nonlinear handling region in accordance with some examples of the present disclosure.

FIG. 9 illustrates an image of a driving environment, an ABS activation signal, and a tire road friction limit estimate signal in accordance with some examples of the present disclosure.

FIG. 10 illustrates an example of an AV management system.

### DETAILED DESCRIPTION OF EMBODIMENTS

Many road accidents are caused by the inability of drivers to control a vehicle at its friction limits. The friction between the tires of a vehicle and the road determines a maximum acceleration, and more importantly a minimum stopping distance. Some approaches monitor tire signals and determine slip angles, which are difficult to determine quickly and accurately. The tire road friction limit is also difficult to calculate from the tire signals and slip angles in a timely manner to assist in collision avoidance.

Vehicle systems and a method for determining tire road limit nearness estimation are described. Lateral and longitudinal force disturbance signals are determined for a vehicle and then used for determining the tire road limit nearness estimation that indicates a limit nearness quantity to provide an ability in real time to dynamically push a vehicle close to or at a tire road limit for certain driving conditions to avoid a collision or maintain course on a road.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

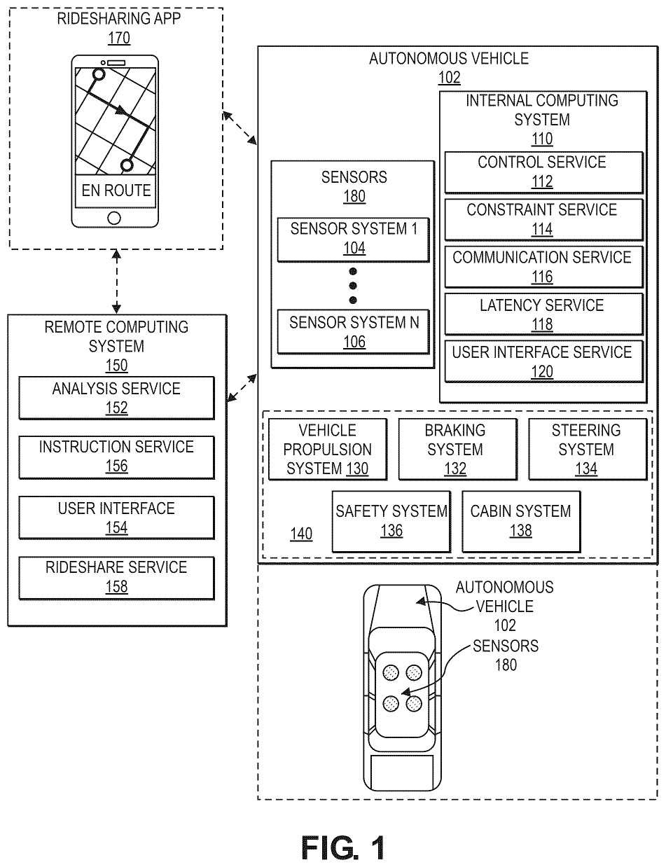

FIG. 1 illustrates an autonomous vehicle and remote computing system architecture in accordance with some examples of the present disclosure. The autonomous vehicle 102 can navigate about roadways without a human driver based upon sensor signals output by sensor systems 180 of the autonomous vehicle 102. The autonomous vehicle 102 includes a plurality of sensor systems 180 (e.g., a first sensor system 104 through an Nth sensor system 106). The sensor systems 180 are of different types and are arranged about the autonomous vehicle 102. For example, the first sensor system 104 may be a camera sensor system and the Nth sensor system 106 may be a Light Detection and Ranging (LIDAR) sensor system to perform ranging measurements for localization. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it should be understood that more or fewer sensors may be coupled to the autonomous vehicle 102.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. In some cases, the braking system 132 may charge a battery of the vehicle through regenerative braking. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 180 and the systems 130, 132, 134, 136, and 138. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 180 and human co-pilots, etc.

The internal computing system 110 can include a control service 112 that is configured to control operation of a mechanical system 140, which includes vehicle propulsion system 130, the braking system 208, the steering system 134, the safety system 136, and the cabin system 138. The control service 112 receives sensor signals from the sensor systems 180 and communicates with other services of the internal computing system 110 to effectuate operation of the autonomous vehicle 102. In some embodiments, control service 112 may carry out operations in concert with one or more other systems of autonomous vehicle 102. The control service 112 can control driving operations of the autonomous vehicle 102 based on sensor signals from the sensor systems 180. In one example, the control service receives sensor signals to monitor driving operations and to determine localization of the vehicle. The control service determines lateral force disturbances for front and rear lateral accelerations and a bulk longitudinal force disturbance for the vehicle based on the localization and the sensor signals. The control service determines a tire road limit nearness estimation for the vehicle based on the sensor signals, the lateral force disturbances for front and rear lateral accelerations and a bulk longitudinal force disturbance.

The internal computing system 110 can also include a constraint service 114 to facilitate safe propulsion of the autonomous vehicle 102. The constraint service 114 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions, etc. The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate machine learning algorithms for operating the autonomous vehicle 102 such as performing object detection for methods and systems disclosed herein. The analysis service 152 can also perform analysis pertaining to data associated with one or more errors or constraints reported by autonomous vehicle 102. In another example, the analysis service 152 is located within the internal computing system 110.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

The rideshare service 158 as depicted in FIG. 1 illustrates a vehicle 102 as a triangle en route from a start point of a trip to an end point of a trip, both of which are illustrated as circular endpoints of a thick line representing a route traveled by the vehicle. The route may be the path of the vehicle from picking up the passenger to dropping off the passenger (or another passenger in the vehicle), or it may be the path of the vehicle from its current location to picking up another passenger.

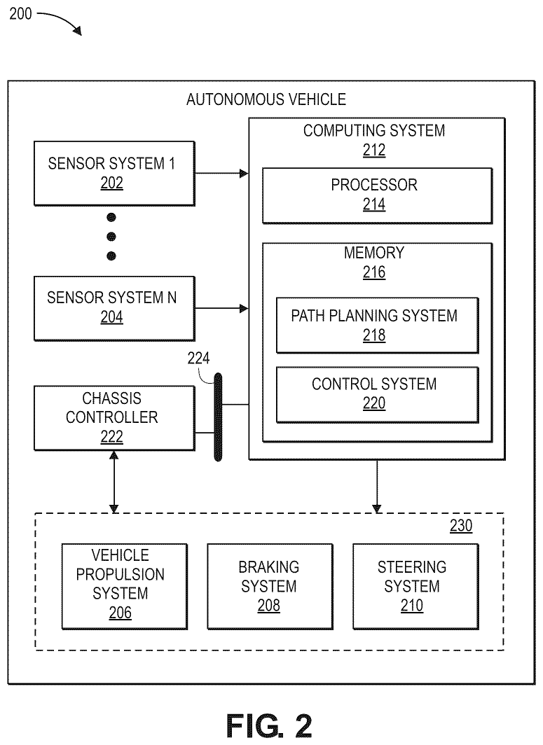

FIG. 2 illustrates an exemplary autonomous vehicle 200 in accordance with some examples of the present disclosure. The autonomous vehicle 200 can navigate about roadways without a human driver based upon sensor signals output by sensor systems 202-204 of the autonomous vehicle 200. The autonomous vehicle 200 includes a plurality of sensor systems 202-204 (a first sensor system 202 through an Nth sensor system 204). The sensor systems 202-204 are of different types and are arranged about the autonomous vehicle 200. For example, the first sensor system 202 may be a camera sensor system and the Nth sensor system 204 may be a lidar sensor system. Other exemplary sensor systems include, but are not limited to, radar sensor systems, global positioning system (GPS) sensor systems, inertial measurement units (IMU), infrared sensor systems, laser sensor systems, sonar sensor systems, and the like. Furthermore, some or all of the of sensor systems 202-204 may be articulating sensors that can be oriented/rotated such that a field of view of the articulating sensors is directed towards different regions surrounding the autonomous vehicle 200.

The autonomous vehicle 200 further includes several mechanical systems that can be used to effectuate appropriate motion of the autonomous vehicle 200. For instance, the mechanical systems 230 can include but are not limited to, a vehicle propulsion system 206, a braking system 208, and a steering system 210. The vehicle propulsion system 206 may include an electric motor, an internal combustion engine, or both. The braking system 208 can include an engine break, brake pads, actuators, and/or any other suitable componentry that is configured to assist in decelerating the autonomous vehicle 200. The steering system 210 includes suitable componentry that is configured to control the direction of movement of the autonomous vehicle 200 during propulsion.

The autonomous vehicle 200 additionally includes a chassis controller 222 that is activated to manipulate the mechanical systems 206-210 when an activation threshold of the chassis controller 222 is reached.

The autonomous vehicle 200 further comprises a computing system 212 that is in communication with the sensor systems 202-204, the mechanical systems 206-210, and the chassis controller 222. While the chassis controller 222 is activated independently from operations of the computing system 212, the chassis controller 222 may be configured to communicate with the computing system 212, for example, via a controller area network (CAN) bus 224. The computing system 212 includes a processor 214 and memory 216 that stores instructions which are executed by the processor 214 to cause the processor 214 to perform acts in accordance with the instructions.

The memory 216 comprises a path planning system 218 and a control system 220. The path planning system 218 generates a path plan for the autonomous vehicle 200, wherein the path plan can be identified both spatially and temporally according to one or more impending timesteps. The path plan can include one or more maneuvers to be performed by the autonomous vehicle 200.

The control system 220 is configured to control the mechanical systems of the autonomous vehicle 200 (e.g., the vehicle propulsion system 206, the brake system 208, and the steering system 210) based upon an output from the sensor systems 202-204 and/or the path planning system 218. For instance, the mechanical systems can be controlled by the control system 220 to execute the path plan determined by the path planning system 218. Additionally or alternatively, the control system 220 may control the mechanical systems 206-210 to navigate the autonomous vehicle 200 in accordance with outputs received from the sensor systems 202-204.

The control system 220 can control driving operations of the autonomous vehicle 200 based on sensor signals from the sensor systems. In one example, the control system receives sensor signals to monitor driving operations and to determine localization of the vehicle. The control service determines lateral force disturbances for front and rear lateral accelerations and a bulk longitudinal force disturbance for the vehicle based on the localization and the sensor signals. The control system determines a tire road limit nearness estimation for the vehicle based on the sensor signals, the lateral force disturbances for front and rear lateral accelerations and a bulk longitudinal force disturbance.

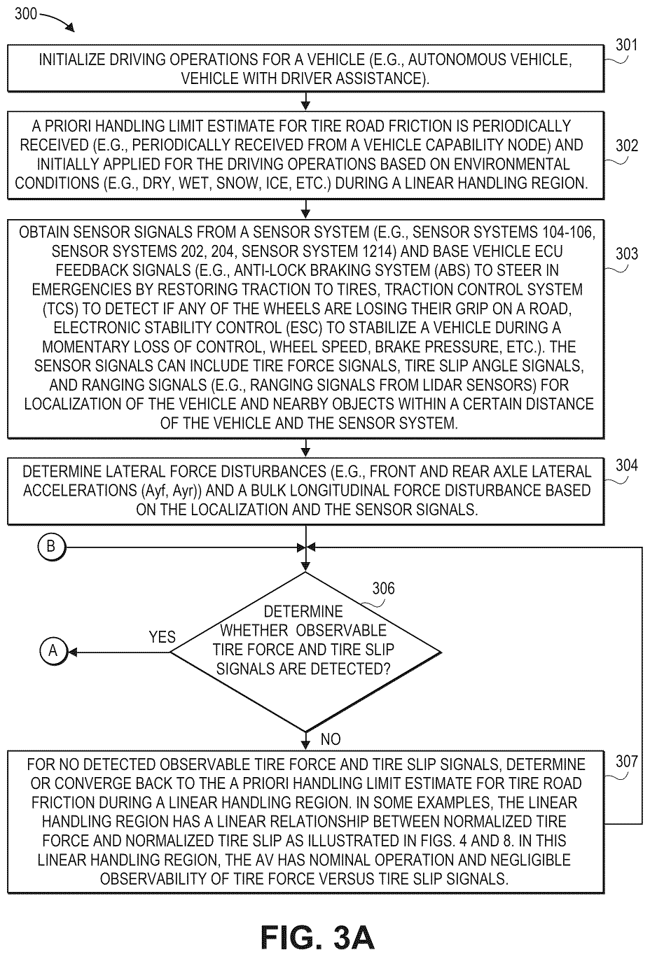

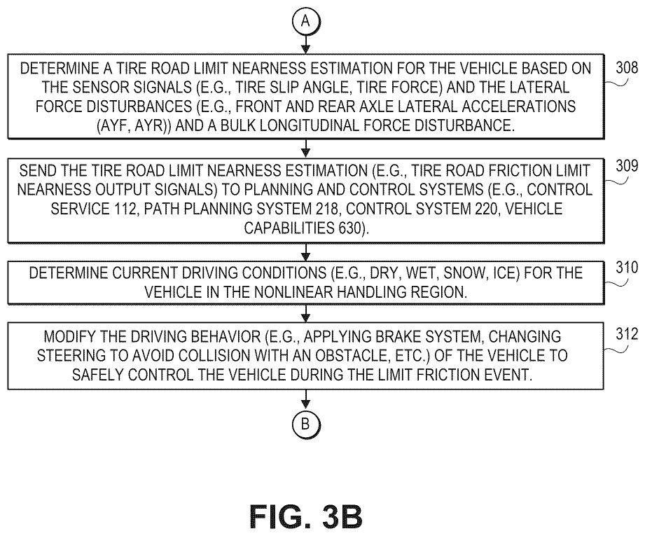

FIGS. 3A and 3B illustrate a computer-implemented method 300 for determining a tire road limit nearness estimation (e.g., tire road friction limit nearness estimation) based on sensor signals from a sensor system and lateral and longitudinal force disturbance signals in accordance with some examples of the present disclosure. In one example, sensor signals with sensor data can be obtained from different types of sensors that are coupled to a device, which may be a vehicle, such as vehicle 102, vehicle 200, AV 402, or vehicle 1200. This computer-implemented method 300 can be performed by processing logic of a computing system that may comprise hardware (circuitry, dedicated logic, a processor, etc.), software (such as is run on a general purpose computer system or a dedicated machine or a device or control service 112), or a combination of both. The method 300 can be performed by an internal or remoting computing system of FIG. 1, the computing system 212 of FIG. 2, local computing device 490, or the system 1202.

Estimated disturbances due to nonlinear tire responses (e.g., approaching the friction limit) are determined to obtain a tire road limit nearness estimation to indicate a limit nearness quantity as opposed to an absolute tire friction value. At operation 301, the computer-implemented method 300 initializes driving operations for a vehicle (e.g., autonomous vehicle, vehicle with driver assistance). In some examples, at operation 302, a priori handling limit estimate for tire road friction is periodically received (e.g., periodically received from a vehicle capability node) and initially applied for the driving operations based on environmental conditions (e.g., dry, wet, snow, ice, etc.) during a linear handling region. The a priori handling limit estimate is deduced or reasoned based on the environmental conditions.

At operation 303, the computer-implemented method 300 obtains sensor signals from a sensor system (e.g., sensor systems 104-106, sensor systems 202, 204, 404, 406, 408, sensor system 1214) and base vehicle electronic control unit (ECU) feedback signals (e.g., anti-lock braking system (ABS) to steer in emergencies by preventing wheel lock in braking events and restoring traction to tires, traction control system (TCS) to detect if any of the wheels are losing their grip on a road and prevent wheel spin during traction events, electronic stability control (ESC) to stabilize a vehicle during a momentary loss of control and prevent excessive lateral slip in cornering events, wheel speed, brake pressure, etc.). An ECU receives input from one or more parts of a vehicle and uses the input to take action if needed. The sensor signals can include tire force signals, tire slip angle signals, and ranging signals (e.g., ranging signals from LIDAR sensors) for localization of the vehicle and nearby objects within a certain distance of the vehicle and the sensor system. Localization of the vehicle may include determining location of the tires and chassis. The signals can be provided as inputs to a state estimator (e.g., LPC state estimator 620). At operation 304, the computer-implemented method 300 determines lateral force disturbances (e.g., front and rear axle lateral accelerations (a_{yf}, a_{yr})) and a bulk longitudinal force disturbance based on the localization and the sensor signals.

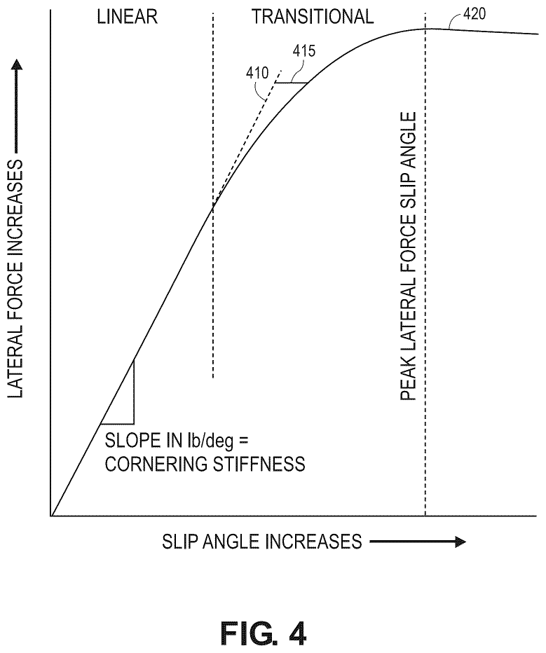

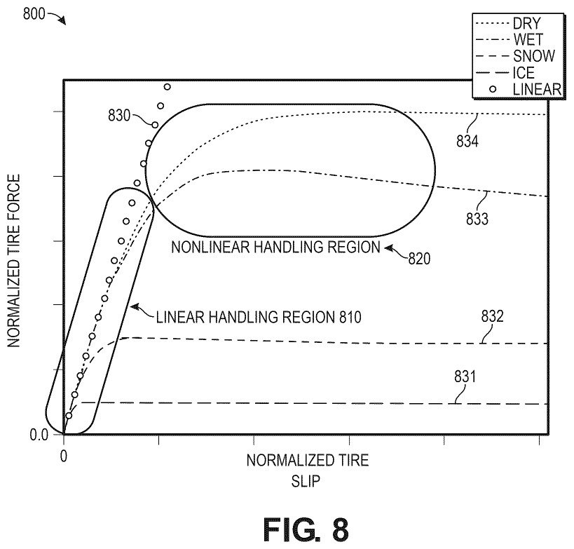

At operation 306, the computer-implemented method 300 determines whether observable tire force and tire slip signals are detected to indicate a limit friction event for a nonlinear handling region. The base vehicle ECU feedback signals if activated may also indicate a limit friction event. If so, the computer-implemented method 300 determines a tire road limit nearness estimation for the vehicle based on the sensor signals (e.g., tire slip angle, tire force) and the lateral force disturbances (e.g., front and rear axle lateral accelerations (a_{yf}, a_{yr})) and a bulk longitudinal force disturbance at operation 308. If not, for no detected observable tire force and tire slip signals, the computer implemented method 300 at operation 307 determines or converges back to the a priori handling limit estimate for tire road friction during a linear handling region. In some examples, the linear handling region has a linear relationship between normalized tire force and normalized tire slip as illustrated in FIGS. 4 and 8. In this linear handling region, the AV has nominal operation and negligible observability of tire force versus tire slip signals.

At operation 309, the tire road limit nearness estimation (e.g., tire road friction limit nearness output signals) can be sent to planning and control systems (e.g., control service 112, path planning system 218, control system 220, vehicle capabilities 630). At operation 310, the computer implemented method 300 determines current driving conditions (e.g., dry, wet, snow, ice, etc.) for the vehicle in the nonlinear handling region and at operation 312 modifies the driving behavior (e.g., applying brake system, changing steering to avoid collision with an obstacle, etc.) of the vehicle to safely control the vehicle during the limit friction event. The tire road limit nearness estimation is applied for modifying the driving behavior.

The vehicle is able to operate close to or exceed the tire road friction limit for certain driving conditions such as avoiding a collision by engaging brakes or changing steering in the vehicle. In one example, for dry driving conditions at lower speeds, applying brakes may be desired to avoid the collision. In another example, for wet driving conditions at lower speeds or 45-65 mph, then a change in steering may be a desired corrective action to avoid the collision. In another example, a double lane change is being performed by the vehicle and the method causes the vehicle to operate at the tire road limit nearness estimation.

The method 300 can proceed from operation 307 or operation 312 back to a previous operation (e.g., operation 306). Operation 306 will be performed continuously or periodically as new or updated information is obtained (e.g., change in detection of tire force and tire slip signals, new or updated sensor signals, change in driving conditions).

FIG. 4 illustrates a tire force versus slip angle diagram in accordance with some examples of the present disclosure. A dashed line 410 represents an ideal linear lateral tire force to slip angle relationship. One or more disturbance(s) 415 can cause a change in slip angle from the line 410 to a non-linear force to slip angle signal 420. The slip angle is the angle (degrees) formed between the actual direction of travel of the wheel and the ‘pointing’ direction of the wheel (perpendicular to the axis of rotation). There is an angle between the two when a lateral acceleration is experienced by a vehicle. Lateral acceleration acts transversely to a direction of travel of a vehicle. Lateral acceleration is noticed when driving through a bend in a road as a centrifugal force towards the outside of the bend. Longitudinal acceleration is positive in a direction of forward travel of the vehicle.

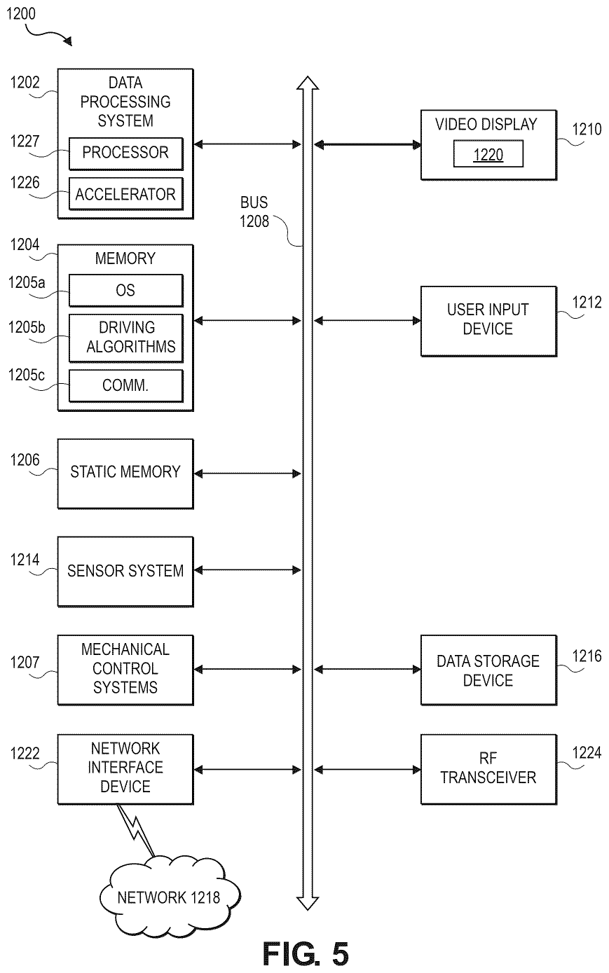

FIG. 5 is a block diagram of a vehicle 1200 having driver assistance according to some examples of the present disclosure. Within the processing system 1202 (or computer system 1202) is a set of instructions for causing the machine to perform any one or more of the methodologies discussed herein including machine learning operations for object detection and part segmentation. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The processing system 1202, as disclosed above, includes processing logic in the form of a general purpose instruction-based processor 1227 or an accelerator 1226 (e.g., graphics processing units (GPUs), FPGA, ASIC, etc.)). The general purpose instruction-based processor may be one or more general purpose instruction-based processors or processing devices (e.g., microprocessor, central processing unit, or the like). More particularly, processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Processing system 1202 is configured to perform the operations and methods discussed herein. The exemplary vehicle 1200 includes a processing system 1202, main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed herein may be configured to implement the data storing mechanisms for performing the operations and methods discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1202. Furthermore, memory 1206 may store additional modules and data structures not described above.

Operating system 1205a includes various procedures, sets of instructions, software components and/or drivers for controlling and managing general system tasks and facilitates communication between various hardware and software components. Driving algorithms 1205b (e.g., method 300, object detection, driver assistance, etc.) utilize sensor data from the sensor system 1214 to provide object detection, segmentation, driver assistance features, and tire road friction limit nearness estimation for different applications such as driving operations of vehicles. A communication module 1205c provides communication with other devices utilizing the network interface device 1222 or RF transceiver 1224.

The vehicle 1200 may further include a network interface device 1222. In an alternative embodiment, the data processing system disclosed is integrated into the network interface device 1222 as disclosed herein. The vehicle 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), and a Graphic User Interface (GUI) 1220 (e.g., a touch-screen with input & output functionality) that is provided by the display 1210.

The vehicle 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The data storage device 1216 may include a machine-readable storage medium (or more specifically a non-transitory computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202, the main memory 1204 and the data processing system 1202 also constituting machine-readable storage media.

In one example, the vehicle 1200 with driver assistance is an autonomous vehicle that may be connected (e.g., networked) to other machines or other autonomous vehicles using a network 1218 (e.g., LAN, WAN, cellular network, or any network). The vehicle can be a distributed system that includes many computers networked within the vehicle. The vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The vehicle can operate in the capacity of a server or a client in a client-server network environment, or as a peer machine in a peer-to-peer (or distributed) network environment. The storage units disclosed in vehicle 1200 may be configured to implement data storing mechanisms for performing the operations of autonomous vehicles.

The vehicle 1200 also includes sensor system 1214 and mechanical control systems 1207 (e.g., chassis control, vehicle propulsion system, driving wheel control, brake control, etc.). The system 1202 executes software instructions to perform different features and functionality (e.g., driving decisions) and provide a graphical user interface 1220 for an occupant of the vehicle. The system 1202 performs the different features and functionality for autonomous operation of the vehicle based at least partially on receiving input from the sensor system 1214 that includes lidar sensors, cameras, radar, GPS, and additional sensors. The system 1202 may be an electronic control unit for the vehicle.

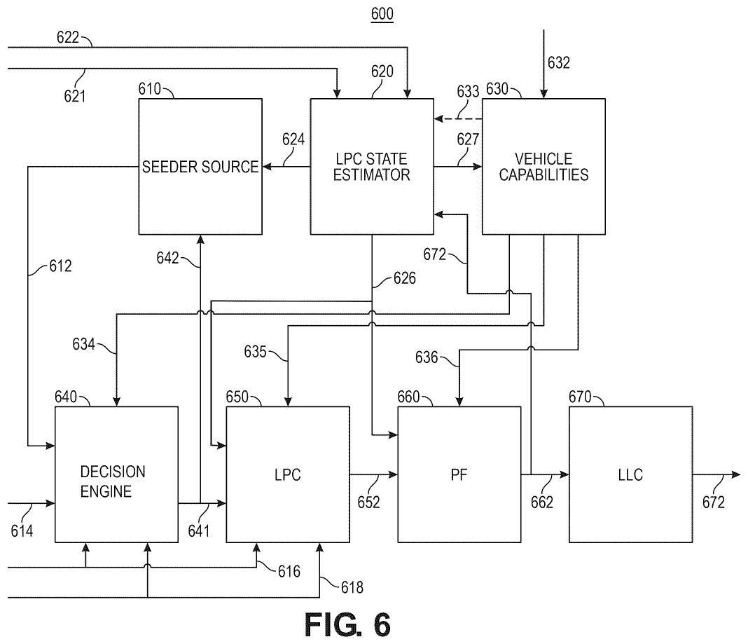

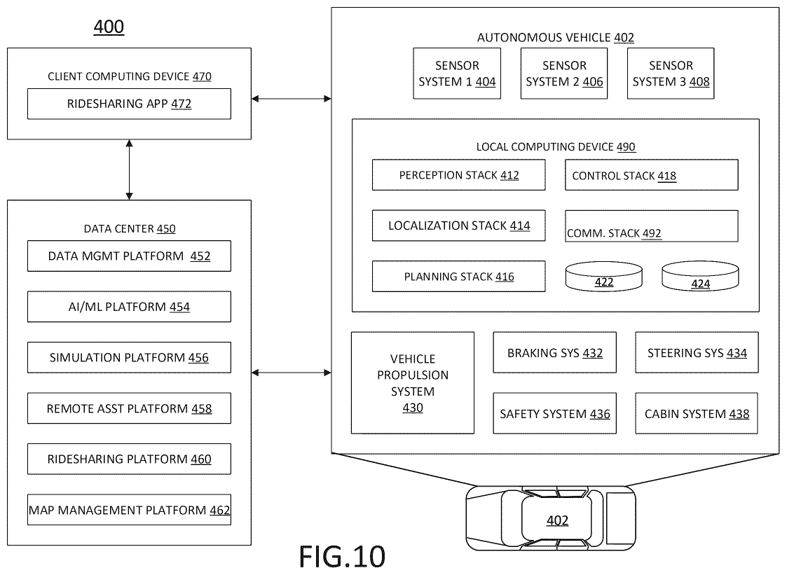

FIG. 6 illustrates a block diagram of a control system for dynamic modeling of a vehicle in accordance with some examples of the present disclosure. The control system 600 is configured to control the mechanical systems of an autonomous vehicle (e.g., vehicle propulsion system 130, brake system 132, and steering system 134 of FIG. 1, vehicle propulsion system 206, brake system 208, and steering system 210 of FIG. 2, vehicle propulsion system 430, braking system 432, and steering system 434 of FIG. 10) based upon output from sensor systems, ECU feedback, and/or the path planning system. In one example, sensor signals with sensor data can be obtained from different types of sensors that are coupled to a device or onboard the device, which may be a vehicle, such as AV 102, AV 200, vehicle 1200, or AV 402. The operations of components or modules of the control system 600 can be performed by processing logic of a computing system that may comprise hardware (circuitry, dedicated logic, a processor, etc.), software (such as is run on a general purpose computer system or a dedicated machine or a device or control service 112), or a combination of both. The operations can be performed by an internal computing system 110 or remoting computing system 150 of FIG. 1, the computing system 212 of FIG. 2, local computing device 490, or the system 1202.

The control system 600 of a vehicle includes a seeder source 610, a local planner controller (LPC) state estimator 620, a vehicle capabilities node 630, a decision engine 640 of a planning stack (e.g., a decision engine 640 of a planning stack 416, a coupled solver and massively parallel planner of the planning stack 416), a LPC 650, a path follower 660, and a low level controller (LLC) 670. The path follower (PF) 660 is a primary algorithmic component of the control stack. The LLC 670 is a thin adapter like component of the control stack.

The seeder source 610 provides initial condition management with an initial condition being provided with signal 612 to the decision engine 640. The initial condition may include pose, one or more velocities, one or more accelerations, and commands for the vehicle. The seeder source 610 provides a nominal open loop planner operation, a bounded convergence in off-nominal cases, and a continuous pose guarantee for the AV.

The seeder source 610 enables self-seeding of the decision engine 640. This change is necessitated by the separation of the decision engine 640 and LPC seeds. Accordingly, the seeder convergence algorithm will therefore function to bound decision engine 640 versus LPC 650.

In one example, the LPC 650 is a canonical reference follower to the decision engine 640. This is accomplished by separating the initial conditions (a.k.a., seeds) of the decision engine 640 and the LPC 650. Then, the LPC 650 operates on a tracking offset from a reference plan of the decision engine 640. A reference plan indicates kinematically and dynamically feasible paths for the AV assuming no obstacles on a road.

A seeder convergence algorithm is applied to bound the offset between these two seeds, correcting a higher-level seed as needed. A common seed is equivalent to a seeder convergence algorithm with bounds set to zero. As such, an incremental approach is to start with reasonably tight bounds on allowed divergence. This serves both to reduce risk and provide a signal on improvements needed in the decision engine 640 and the LPC 650 to enable the bounds to grow. The seeder convergence algorithm provides a continuous pose guarantee.

The LPC 650 receives full AV state information (e.g., pose, one or more velocities, one or more accelerations, commands, and force disturbance estimates for the vehicle) from signal 626, has full control authority, and some knowledge of urgent/critical obstacles ahead for a vehicle. The local planner controller (LPC) state estimator 620 provides the full AV state information including disturbance estimates to the LPC 650.

Not only does separating the seeds have a behavioral benefit, separating the seeds also has a latency benefit. In one example, for a common seed of a previous approach, a planning component that is downstream of a solver provides a solution before a subsequent solve can be triggered. If the planning metronome ticks with new inputs and the planning component hasn't yet completed, this causes skipping that tick.

By separating the seeds, these skipped ticks of the common seed can be triggered. As a result, separating the seeds could be among the larger impacts that reduce end to end global latency for planning and control. In addition to addressing decision engine (or solver) skipped ticks, separating the initial conditions (a.k.a., seeds) of the decision engine 640 and the LPC 650 can give additional headroom if needed for compute-intensive loads.

Once the decision engine 640 is self-seeding, the LPC 650 transitions to seed off of the actual AV pose and this enables some key advantages. First, this change for the LPC 650 radically reduces offset from planned pose to actual AV pose. With LPC 650 and PF 660 starting from the same initial condition, this offset becomes nominally zero. Only small amounts would accumulate due to the latency and tick rate of LPC 650. This eliminates the potential safety risk of the AV “blindly” deviating from the plan into obstacles, which currently is mitigated by buffers. Second, this change shrinks spatial buffers. As a consequence of the above, the footprint and obstacle buffers in LPC 650 can be reduced. This will decrease occasions where LPC 650 could inadvertently modify a solution of the decision engine 640.

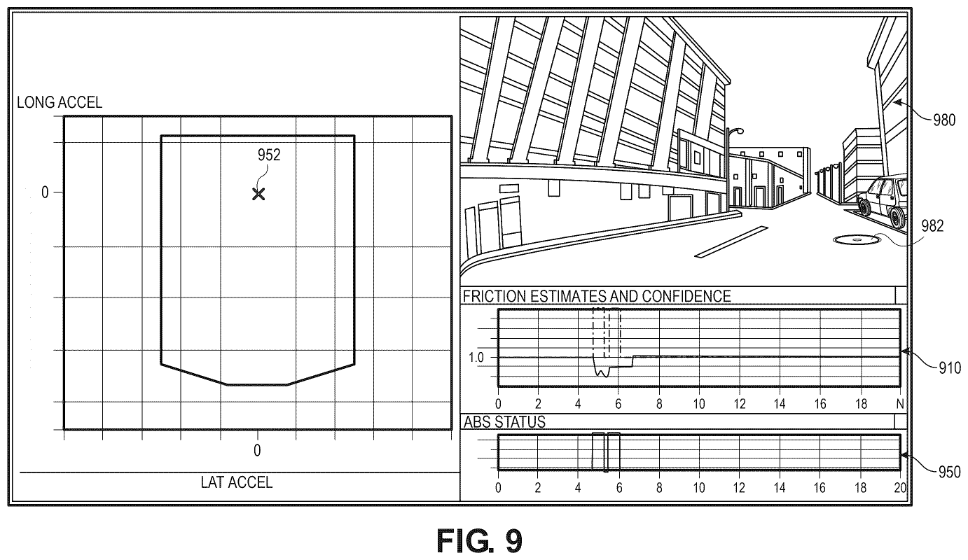

Third, this change provides full controls authority to the LPC 650. In addition to spatial buffers, actuation buffers can also be removed. This provides LPC 650 with the full amount of acceleration, deceleration, curvature, and lateral maneuvering as the control stack (e.g., control stack 418 of FIG. 9). This provides a safety improvement as well as multiplies the impact of turning tighter to navigate narrow gaps for the AV.

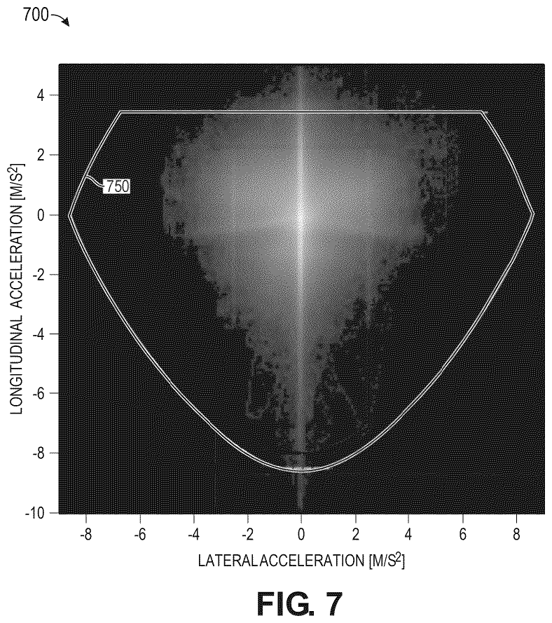

FIG. 7 illustrates longitudinal acceleration on a y-axis versus lateral acceleration on a x-axis of diagram 700. The LPC 650 with full controls authority operates over a wide region within the friction envelope 750. The AV can safely operate within the friction envelope 750 and can not support tire friction values outside of the friction envelope.

In some examples, the LPC 650 can include a lateral planner and a longitudinal planner as separate components. The longitudinal planner can be encoded with coupled constraints (e.g., lateral acceleration, longitudinal acceleration) for the AV's path even though the LPC 650 may not be a coupled decision engine in contrast with the decision engine 640 that can be a single coupled model for longitudinal and lateral constraints. However, in another example, the LPC 650 can be a coupled decision engine.

Considerations needed to enable this increased authority of LPC 650 include scheduling and recursive stability. With the consumption of a higher-frequency signal 626 of the actual AV state, LPC 650 will now have a reason to tick more frequently than previously when LPC did not have full controls authority. In essence, this change adds another trigger for a scheduler to consider in a multi-rate planner that enables the LPC 650 to operate independently of the decision engine 640.

With the initial condition of LPC 650 no longer determined by its own open-loop plan, there is risk that LPC 650 can not execute these plans in closed-loop with the AV. The LPC 650 could be influenced by the AV's dynamics. One key mitigation is disturbance rejection in a similar manner as inclusion of disturbances for PF 660 enabled tight following of the LPC. In one example, inclusion of the disturbances for LPC 650 is needed to ensure that LPC 650 can tightly follow the reference plan of the decision engine 640.

An important consequence of the strengthening of the reference following of the LPC 650 and use of the LPC 650 as a planner controller is enabling detection of and operation at the handling limits (a.k.a. “friction limits”). This increases our vehicle capabilities envelope to enable better obstacle avoidance, yielding safety improvements in both dry conditions and, even more so, in inclement weather.

A key challenge of handling at the handling limits is observability of tire signals. While the AV can and does observe tire slip, this alone doesn't produce a meaningful signal for the underlying friction limit. The tire friction limit is only observable once the vehicle is operating in a nonlinear handling region, where the tire force vs. slip relationship notably deviates from the linear expectation.

FIG. 8 illustrates a tire force versus tire slip angle diagram 800 with linear handling region 810 and nonlinear handling region 820 in accordance with some examples of the present disclosure. Since the real-world tire force versus tire slip relationship is notably more noisy and variable than the above diagram 800 may imply, the net effect is that a meaningful signal for observing tire friction limit is only available and observed during limit friction events that occur in the nonlinear handling region 820. This is effectively synonymous with when adaptive driver assistance systems (ADAS) intervention (e.g., ABS for braking, TCS for traction, . . . ) occurs, since ADAS can't act much sooner due to the same observability problem.

For the linear handling region 810, the observed signals 831-834 for ice, snow, wet, and dry are primarily aligned with a linear signal 830. The vehicle is operating in nominal operation with negligible observability of signals for the tire friction limit during the linear handling region.

Returning to FIG. 6, the control system 600 is able to manage limit handling as follows. The LPC state estimator 620 receives ADAS ECU feedback as signal 622. By including this ECU feedback into the existing AV state estimation, the LPC state estimator 620 can both produce a handling limit estimate and improve existing state and disturbance estimates.

The control system 600 enables effective operation at the handling limits. This ability is contingent on having a component that understands how to trade off urgent obstacle constraints against vehicle handling limits. With access to the complete AV state, controls authority, and urgent obstacle information, the LPC 650 fulfills that role.

The control system 600 ensures effective detection of the handling limits. Due to the limits only being observable when operating at the handling limits, the control system 600 constantly pushes against the handling limits if needed to avoid an urgent obstacle. By providing LPC 650 and the decision engine 640 slightly different limits (e.g., 105-110% of handling limits for LPC 650 vs. 95-100% of handling limits for decision engine 640), the control system 600 can simultaneously have LPC 650 keep probing at the constantly varying limits while the decision engine 640 looks for a less-risky path (e.g., veer instead of brake to avoid an obstacle).

In one example, the control system 600 provides emergent properties without hard coding. If an obstacle arises near the AV, then AV responds by starting to slam on the brakes, engages ABS, and requests 0.9 G for braking. A g-force is a measure of acceleration. Human passengers experience a g-force during braking. However, due to the current detected tire friction limit that changes rapidly, 0.7 G may only be provided so the decision engine 640 stops at 0.7 G. The LPC 650 can push for a higher tire friction limit and thus be able to receive greater than 0.7 G for braking, which may be a better solution to avoid an urgent or critical obstacle.

Below is an example that illustrates the importance of the above strategy. In this example, an ABS activation signal 950 of FIG. 9 is received by the control system 600. This provides a signal of approaching or reaching handling limits of the AV. Initially, the friction limit estimate 910 overshoots low (e.g., below 1 on y-axis) when the ABS signal is activated, then the friction limit estimate 910 recovers back to 1. This illustrates that the friction limit estimate is highly variable. The street image 980 indicates why the friction limit estimate is highly variable. The road surface is dry, but the AV drives over a maintenance hole cover 982 in the right lane. The steel maintenance hole cover 982 has a markedly lower friction than an asphalt road surface. However, this surface change is temporary, lasting only ˜1 meter of travel per axle. The left side of FIG. 9 shows longitudinal acceleration on a y axis and lateral acceleration on a x axis. The marker 952 shows an initial data point. During the activation of the ABS signal due to front and rear axles driving over the maintenance hole cover 982, the marker 952 moves downwards to a longitudinal acceleration of approximately negative 6 m/s2. The AV is braking in response to the activation of the ABS signal even though the AV does not need to brake for driving over a maintenance hole cover.

Embodiments of the present disclosure address these concerns, ensuring that the AV minimizes stopping distance when needed while also keeping the planner better informed of its capabilities.

Importantly, the LPC 650 will continue reducing the obstacles to more “urgent” obstacles for consideration. These urgent obstacles should only affect costing in truly critical events.

The LPC 650 infers interactions from the reference plan of the decision engine 640. Rather than “rethink” a solution to produce a set of separately determined (and hard-to-maintain) semantic flags, LPC will use the reference plan of the decision engine 640 to infer the AV's relationship to obstacles. One key metric guiding the above is the frequency at which obstacle constraints are active in LPC's solution. Another is the degree to which the LPC supports severity sensitive tradeoffs made by the decision engine.

Returning to FIG. 6, the LPC state estimator 620 receives base vehicle ECU feedback signal(s) (e.g., anti-lock braking system (ABS) to steer in emergencies by restoring traction to tires, traction control system (TCS) to detect if any of the wheels are losing their grip on a road, electronic stability control (ESC) to stabilize a vehicle during a momentary loss of control, wheel speed, brake pressure, etc.) at a higher frequency (e.g., 100 hertz) from an ECU module, receives localization information for the vehicle via signal 621 at a higher frequency (e.g., 100 hertz), and receives expected state for the vehicle from output of PF 660 via signal 672. The LPC state estimator 620 provides actual state of the vehicle to the seeder source and vehicle capabilities 630 via signals 624 and 626, respectively. The LPC state estimator 620 provides the initial condition for LPC 650 and PF 660 with signal 626. This is important for the planner controller concept. This initial state includes pose, one or more velocities, one or more accelerations, commands, and disturbance estimates. The LPC state estimator 620 also provides road grade angle and road bank estimation. This enables algorithm improvements for the AV state. The core domain knowledge of the LPC State Estimator 620 relates to vehicle dynamics.

Poor rejection of disturbances such as road banks, road grades, steering misalignment, suspension misalignment, and variation in tire pressure can cause a large lateral controls error bias. Most in-block roads are crowned, causing a bank angle on the right and the left side of the road. Driving mostly on the right side of the road, following the traffic rules, in absence of effective disturbance rejection, increases control error on the right. A disturbance is a single acceleration or specific force experienced by a vehicle in a travel direction. In one example, a transient disturbance can be cross-winds experienced by the vehicle. Sustained periods of high controls error on left side of vehicle may occur when driving on left side of road, for example, on one way roads. Thus, the road bank is one source of controls pose errors.

The LPC state estimator 620 also provides reactive real-time handling limit estimation for estimating tire road friction limits. Building out this capability is one of the keys to handling at the tire road friction limits, and enables Vehicle Capabilities node 630 to provide real-time adjustments based on base vehicle ECU feedback (e.g., ABS, TCS, ESC, . . . ) from signal 622.

The main features of vehicle capabilities node 630 utilize the LPC State Estimator's observations of handling limits via signal 627 having actual AV state. This includes mapping handling limits to constraints (e.g., acceleration, velocity, curvature, etc.) and performing constraint management. The estimated handling limits enable modified constraints to be provided to each of the planning/control models.

The vehicle capabilities node 630 provides proactive environmental condition management (e.g., dry, wet, snowy, icy, etc.) based on receiving environmental condition signal 632 from on-vehicle detection sensors or from a remote source. The environmental condition signal 632 can be provided at a low frequency (e.g., less than 1 hertz frequency). Vehicle capabilities 630 also provide a priori handling limit estimate via signal 633 at a low frequency (e.g., less than 1 hertz frequency) to the LPC state estimator 620. Based on environmental conditions (e.g., dry, wet, snowy, icy, etc.), this a priori handling limit estimate is what the LPC State Estimator 620 converges back to when the handling limits are not observable.

Vehicle capabilities node 630 modifies model parameters as dictated by handling limits based on receiving signal 627 with actual AV state. The effective tire parameters (e.g., slope of tire force versus tire slip, split-mu effects) used in planning/control models will also change near the handling limits. When the AV is handling at the lateral limits, this will become an important part of how the LPC operates. Vehicle Capabilities includes motion planning dynamics. Core domain knowledge relates to mapping handling limits to constraints and parameters.

The vehicle capabilities node 630 provides capability constraints to the decision engine 640 via a signal 634. The vehicle capabilities node 630 also provides capability constraints and model parameters to the LPC 650 and PF 660 via signals 635 and 636, respectively.

The decision engine 640 receives an initial condition via a signal 612, reference route(s) via a signal 614, a map context via a signal 616, and predictions (e.g., predictions based on camera sensors, LIDAR, predictions of obstacles, other vehicles, etc.) via a signal 618. In some examples, the decision engine 640 is a coupled decision engine for a kinematic bicycle model, operates at a low frequency (e.g., 3-10 hertz), has coarse discretization, and considers all obstacles near a vehicle. The decision engine 640 sends a reference plan to the LPC 650 via a signal 641.

The LPC 650 can implement a dynamic bicycle model with disturbances, operates at a frequency (e.g., 25 to 50 hertz), acts as a reference follower to the decision engine 640, and considers urgent time sensitive obstacles while not considering non-urgent obstacles. The LPC 650 provides a reference plan with the AV's path to the PF 660 via a signal 652.

The PF 660 can implement a dynamic bicycle model with disturbances, operates at a frequency (e.g., 50 to 150 hertz), acts as a reference follower to the LPC 650, and does not consider any obstacles. The PF 660 provides a reference plan with a local path to the LLC 670 via a signal 662. The LLC 670 does not implement a vehicular model, operates at a frequency (e.g., 50 to 150 hertz), can be time triggered, and can perform a lookup for data. The LLC 670 provides actuator commands via a signal 672. The LLC 670 may include a delay compensation module that receives the reference plan via signal 662, determines delay (e.g., from actuators), and compensates for the delay by sending the actuator commands in output ahead of a current time.

Turning now to FIG. 10, this figure illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate about roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

AV 402 can also include several mechanical systems that can be used to maneuver or operate AV 402. For instance, the mechanical systems can include vehicle propulsion system 430, braking system 432, steering system 434, safety system 436, and cabin system 438, among other systems. Vehicle propulsion system 430 can include an electric motor, an internal combustion engine, or both. The braking system 432 can include an engine brake, a wheel braking system (e.g., a disc braking system that utilizes brake pads), hydraulics, actuators, and/or any other suitable componentry configured to assist in decelerating AV 402. The steering system 434 can include suitable componentry configured to control the direction of movement of the AV 402 during navigation. Safety system 436 can include lights and signal indicators, a parking brake, airbags, and so forth. The cabin system 438 can include cabin temperature control systems, in-cabin entertainment systems, and so forth. In some embodiments, the AV 402 may not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

AV 402 can additionally include a local computing device 490 that is in communication with the sensor systems 404-408, the mechanical systems 430-438, the data center 450, and the client computing device 470, among other systems. The local computing device 490 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 490 includes a perception stack 412, a mapping and localization stack 414, a planning stack 416, a control stack 418, a communication stack 492, an High Definition (HD) geospatial database 422, and an AV operational database 424, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 422, other components of the AV, and other data sources (e.g., the data center 450, the client computing device 470, third-party data sources, etc.). The perception stack 412 can detect and classify objects and determine their current and predicted locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth.

Mapping and localization stack 414 can determine the AV's position and orientation (pose) using different methods from multiple systems (e.g., GPS, IMUs, cameras, LIDAR, RADAR, ultrasonic sensors, the HD geospatial database 422, etc.). For example, in some embodiments, the AV 402 can compare sensor data captured in real-time by the sensor systems 404-408 to data in the HD geospatial database 422 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The planning stack 416 can determine how to maneuver or operate the AV 402 safely and efficiently in its environment. For example, the planning stack 416 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 402 from one point to another. The planning stack 416 can determine multiple sets of one or more mechanical operations that the AV 402 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 416 can select from multiple backup plans to carry out. For example, while preparing to change lanes to turn right at an intersection, another vehicle may aggressively cut into the destination lane, making the lane change unsafe. The planning stack 416 could have already determined an alternative plan for such an event, and upon its occurrence, help to direct the AV 402 to go around the block instead of blocking a current lane while waiting for an opening to change lanes.

The control stack 418 can manage the operation of the vehicle propulsion system 430, the braking system 432, the steering system 434, the safety system 436, and the cabin system 438. The control stack 418 can receive sensor signals from the sensor systems 404-408 as well as communicate with other stacks or components of the local computing device 490 or a remote system (e.g., the data center 450) to effectuate operation of the AV 402. For example, the control stack 418 can implement the final path or actions from the multiple paths or actions provided by the planning stack 416. This can involve turning the routes and decisions from the planning stack 416 into commands for the actuators that control the AV's steering, throttle, brake, and drive unit.

The communication stack 492 can transmit and receive signals between the various stacks and other components of the AV 402 and between the AV 402, the data center 450, the client computing device 470, and other remote systems. The communication stack 492 can enable the local computing device 490 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 492 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 422 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 424 can store raw AV data generated by the sensor systems 404-408 and other components of the AV 402 and/or data received by the AV 402 from remote systems (e.g., the data center 450, the client computing device 470, etc.). In some embodiments, the raw AV data can include HD LIDAR point cloud data, image or video data, RADAR data, GPS data, and other sensor data that the data center 450 can use for creating or updating AV geospatial data as discussed further below with respect to FIG. 5 and elsewhere in the present disclosure.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 490 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes one or more of a data management platform 452, an Artificial Intelligence/Machine Learning (AI/ML) platform 454, a simulation platform 456, a remote assistance platform 458, a ridesharing platform 460, and a map management platform 462, among other systems.

Data management platform 452 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the map management platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 472. The client computing device 470 can be a customer's mobile computing device or a computing device integrated with the AV 402 (e.g., the local computing device 490). The ridesharing platform 460 can receive requests to be picked up or dropped off from the ridesharing application 472 and dispatch the AV 402 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client ridesharing application 472 to enable passengers to view the AV 402 in transit en route to a pick-up or drop-off location, and so on.

### Selected Examples

The following are non-limiting examples.

Example 1—a computer implemented method comprises obtaining sensor signals from a sensor system of a vehicle to monitor driving operations and to determine localization of the vehicle; determining lateral force disturbances for front and rear lateral accelerations and a bulk longitudinal force disturbance for the vehicle based on the localization and the sensor signals, determining whether tire force and tire slip angle signals are detected to indicate a limit friction event for a nonlinear handling region, and determining a tire road limit nearness estimation for the vehicle based on the tire force and tire slip angle signals, the lateral force disturbances for front and rear lateral accelerations and the bulk longitudinal force disturbance when the tire force and tire slip signals are detected for a nonlinear handling region.

Example 2—the computer implemented method of Example 1, further comprises periodically receiving a priori handling limit estimate for tire road friction from a vehicle capabilities node.

Example 3—the computer implemented method of any of Examples 1-2, further comprises for no detected observable tire force and tire slip signals, applying the a priori handling limit estimate for tire road friction during a linear handling region.

Example 4—the computer implemented method of any of Examples 1-3, further comprises receiving base vehicle electronic control unit (ECU) feedback signals including an anti-lock braking system (ABS) signal, a traction control system (TCS) signal, or an electronic stability control (ESC) to indicate a limit friction event for the nonlinear handling region.

Example 5—the computer implemented method of any of Examples 1-4, further comprises sending the tire road limit nearness estimation to planning and control systems.

Example 6—the computer implemented method of any of Examples 1-5, further comprises determining current driving conditions for the vehicle in the nonlinear handling region; and modifying the driving behavior of the vehicle to safely control the vehicle during the limit friction event in the nonlinear handling region with the tire road limit nearness estimation being applied for modifying the driving behavior.

Example 7—the computer implemented method of any of Examples 1-6, wherein the sensor signals comprise tire force signals, tire slip angle signals, and ranging signals for localization of the vehicle and nearby objects within a certain distance of the vehicle and the sensor system.

Example 8—a computing system, comprising a memory storing instructions and a processor coupled to the memory. The processor is configured to execute instructions of a software program to obtain sensor signals from a sensor system of an autonomous vehicle to monitor driving operations and to determine localization of the autonomous vehicle, determine lateral force disturbances for front and rear lateral accelerations and a bulk longitudinal force disturbance for the autonomous vehicle based on the localization and the sensor signals, determine whether tire force and tire slip signals are detected to indicate a limit friction event for a nonlinear handling region, and determine a tire road limit nearness estimation for the vehicle based on the tire force and tire slip angle signals, the lateral force disturbances for front and rear lateral accelerations and the bulk longitudinal force disturbance when the tire force and tire slip signals are detected for a nonlinear handling region.

Example 9—the computing system of Example 8, wherein the processor is configured to execute instructions to periodically receive a priori handling limit estimate for tire road friction from a vehicle capabilities node.

Example 10—the computing system of any of Examples 8 and 9, wherein the processor is configured to execute instructions to for no detected observable tire force and tire slip signals, apply the a priori handling limit estimate for tire road friction during a linear handling region.

Example 11—the computing system of any of Examples 8-10, wherein the processor is configured to execute instructions to receive base vehicle electronic control unit (ECU) feedback signals including an anti-lock braking system (ABS) signal, a traction control system (TCS) signal, or an electronic stability control (ESC) to indicate a limit friction event for the nonlinear handling region.

Example 12—the computing system of any of Examples 8-11, wherein the processor is configured to execute instructions to send the tire road limit nearness estimation to planning and control systems.

Example 13—the computing system of any of Examples 8-12, wherein the processor is configured to execute instructions to determine current driving conditions for the vehicle in the nonlinear handling region.

Example 14—the computing system of any of Examples 8-13, wherein the processor is configured to execute instructions modify driving behavior of the vehicle to safely control the vehicle during the limit friction event in the nonlinear handling region with the tire road limit nearness estimation being applied for modifying the driving behavior.

Example 15—the computing system of any of Examples 8-14, wherein the sensor signals comprise tire force signals, tire slip angle signals, and ranging signals for localization of the vehicle and nearby objects within a certain distance of the vehicle and the sensor system.

Example 16—a non-transitory computer readable storage medium having embodied thereon a program, wherein the program is executable by a processor to perform a method comprising obtaining sensor signals from a sensor system of a vehicle to monitor driving operations and to determine localization of the vehicle, determining lateral force disturbances for front and rear lateral accelerations and a bulk longitudinal force disturbance for the vehicle based on the localization and the sensor signals, determining whether tire force and tire slip signals are detected to indicate a limit friction event for a nonlinear handling region, and determining a tire road limit nearness estimation for the vehicle based on the tire force and tire slip angle signals, the lateral force disturbances for front and rear lateral accelerations and the bulk longitudinal force disturbance when the tire force and tire slip signals are detected for a nonlinear handling region.

Example 17—the non-transitory computer readable storage medium of Example 16, wherein the method further comprises periodically receiving a priori handling limit estimate for tire road friction from a vehicle capabilities node.

Example 18—the non-transitory computer readable storage medium of any of Examples 16 and 17, wherein the method further comprises receiving base vehicle electronic control unit (ECU) feedback signals including an anti-lock braking system (ABS) signal, a traction control system (TCS) signal, or an electronic stability control (ESC) to indicate a limit friction event for the nonlinear handling region.

Example 19—the non-transitory computer readable storage medium of any of Examples 16-18, wherein the method further comprises determining current driving conditions for the vehicle in the nonlinear handling region and modifying driving behavior of the vehicle to safely control the vehicle during the limit friction event in the nonlinear handling region with the tire road limit nearness estimation being applied for modifying the driving behavior.

Example 20—the non-transitory computer readable storage medium of any of Examples 16-19, wherein the sensor signals comprise tire force signals, tire slip angle signals, and ranging signals for localization of the vehicle and nearby objects within a certain distance of the vehicle and the sensor system.

Example 21—a computer implemented method comprising receiving a feedback signal from an electronic control unit (ECU) of an autonomous vehicle (AV), determining whether tire force and tire slip signals of the AV are detected to indicate a limit friction event for a nonlinear handling region, and determining real-time handling limit estimation including a tire road limit nearness estimation for the AV based partially on the feedback signal when the tire force and tire slip signals are detected for a nonlinear handling region.

Example 22—the computer implemented method of Example 21, further comprising receiving an expected state of an autonomous vehicle (AV), determining an actual state and disturbance estimation of the AV based on the expected state of the AV and the feedback signal, and determining a road grade angle and road bank estimation.

Example 23—the computer implemented method of any of Examples 21 and 22, further comprising providing the actual state and the real-time handling limit estimation for tire road friction during the nonlinear handling region to a vehicle capabilities node.

Example 24—the computer implemented method of any of Examples 21-23, further comprising mapping, with the vehicle capabilities node, the real-time handling limit estimation to constraints for acceleration, velocity, or curvature, and performing constraint management based on the real-time handling limit estimation.

Example 25—the computer implemented method of any of Examples 21-24, further comprising providing proactive environmental condition management based on receiving an environmental condition signal from on-vehicle detection sensors.

Example 26—the computer implemented method of any of Examples 21-25, further comprising modifying model parameters including tire parameters based on the actual state and the real-time handling limit estimation for tire road friction.

Example 27—the computer implemented method of any of Examples 21-26, wherein the feedback signal includes an anti-lock braking system (ABS) signal, a traction control system (TCS) signal, or an electronic stability control (ESC) to indicate a limit friction event for the nonlinear handling region.

Example 28—a computing system, comprising a memory storing instructions, and a processor coupled to the memory. The processor is configured to execute instructions of a software program to receive a feedback signal from an electronic control unit (ECU) of an autonomous vehicle (AV), determine whether tire force and tire slip signals of the AV are detected to indicate a limit friction event for a nonlinear handling region, and determine real-time handling limit estimation including a tire road limit nearness estimation for the AV based partially on the feedback signal when the tire force and tire slip signals are detected for a nonlinear handling region.

Example 29—the computing system of Example 28, wherein the processor is configured to execute instructions to receive an expected state of an autonomous vehicle (AV), determine an actual state and disturbance estimation of the AV based on the expected state of the AV and the feedback signal, and determine a road grade angle and road bank estimation

Example 30—the computer system of any of Examples 28 and 29, wherein the processor is configured to execute instructions to provide the actual state and the real-time handling limit estimation for tire road friction during the nonlinear handling region to a vehicle capabilities node.

Example 31—the computer system of any of Examples 28-30, wherein the processor is configured to execute instructions to map the real-time handling limit estimation to constraints for acceleration, velocity, or curvature and perform constraint management based on the real-time handling limit estimation.

Example 32—the computer system of any of Examples 28-31, wherein the processor is configured to execute instructions to provide proactive environmental condition management based on receiving an environmental condition signal from on-vehicle detection sensors.

Example 33—the computer system of any of Examples 28-32, wherein the processor is configured to execute instructions to modify model parameters including tire parameters based on the actual state and the real-time handling limit estimation for tire road friction.

Example 34—the computer system of any of Examples 28-33, wherein the feedback signal includes an anti-lock braking system (ABS) signal, a traction control system (TCS) signal, or an electronic stability control (ESC) to indicate a limit friction event for the nonlinear handling region.

Example 35 is a non-transitory computer readable storage medium having embodied thereon a program, wherein the program is executable by a processor to perform a method comprising receiving, with a vehicle capabilities node, an actual state of an autonomous vehicle (AV) and a real-time handling limit estimation for tire road friction during the nonlinear handling region, mapping, with the vehicle capabilities node, the real-time handling limit estimation to constraints for acceleration, velocity, or curvature; and performing model parameter management based on the real-time handling limit estimation.

Example 36—the non-transitory computer readable storage medium of Example 35, wherein the method further comprises providing the constraints for acceleration, velocity, or curvature to a decision engine of a planner stack, a local planner controller (LPC), and a path follower.

Example 37—the non-transitory computer readable storage medium of any of Examples 35 and 36, wherein the method further comprises providing model parameters including tire parameters that are based on the real-time handling limit estimation to the LPC and the path follower.

Example 38—the non-transitory computer readable storage medium of any of Examples 35-37, wherein the LPC has full control authority for acceleration, deceleration, curvature, and lateral maneuvering.

Example 39—the non-transitory computer readable storage medium of any of Examples 35-38, wherein the LPC is a canonical reference follower to the decision engine of the planner stack.

Example 40—the non-transitory computer readable storage medium of any of Examples 35-39, wherein the LPC utilizes a first handling limit slightly greater than the real-time handling limit estimation to provide a first path for the AV and the decision engine simultaneously utilizes a second handling limit slightly less than the real-time handling limit estimation to provide a second less-risky path for the AV.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A computer implemented method comprising:
obtaining sensor signals from a sensor system of a vehicle to monitor driving operations and to determine localization of the vehicle;
determining lateral force disturbances for front and rear lateral accelerations and a bulk longitudinal force disturbance for the vehicle based on the localization and the sensor signals;
determining whether tire force and tire slip signals are detected to indicate a limit friction event for a nonlinear handling region; and
determining a tire road limit nearness estimation for the vehicle based on the tire force and tire slip angle signals, the lateral force disturbances for front and rear lateral accelerations and the bulk longitudinal force disturbance when the tire force and tire slip signals are detected for a nonlinear handling region.

2. The computer implemented method of claim 1, further comprising:
periodically receiving a priori handling limit estimate for tire road friction from a vehicle capabilities node.

3. The computer implemented method of claim 2, further comprising:
for no detected observable tire force and tire slip signals, applying the a priori handling limit estimate for tire road friction during a linear handling region.

4. The computer implemented method of claim 1, further comprising:
receiving a feedback signal from an electronic control unit (ECU) including an anti-lock braking system (ABS) signal, a traction control system (TCS) signal, or an electronic stability control (ESC) to indicate a limit friction event for the nonlinear handling region.

5. The computer implemented method of claim 1, further comprising:
sending the tire road limit nearness estimation to planning and control systems.

6. The computer implemented method of claim 1, further comprising:
determining current driving conditions for the vehicle in the nonlinear handling region; and
modifying driving behavior of the vehicle to safely control the vehicle during the limit friction event in the nonlinear handling region with the tire road limit nearness estimation being applied for modifying the driving behavior.

7. The computer implemented method of claim 1, wherein the sensor signals comprise tire force signals, tire slip angle signals, and ranging signals for localization of the vehicle and nearby objects within a certain distance of the vehicle and the sensor system.

8. A computing system, comprising:
a memory storing instructions; and
a processor coupled to the memory, the processor is configured to execute instructions of a software program to:
obtain sensor signals from a sensor system of an autonomous vehicle to monitor driving operations and to determine localization of the autonomous vehicle;
determine lateral force disturbances for front and rear lateral accelerations and a bulk longitudinal force disturbance for the autonomous vehicle based on the localization and the sensor signals;
determine whether tire force and tire slip signals are detected to indicate a limit friction event for a nonlinear handling region; and
determine a tire road limit nearness estimation for the vehicle based on the tire force and tire slip angle signals, the lateral force disturbances for front and rear lateral accelerations and the bulk longitudinal force disturbance when the tire force and tire slip signals are detected for a nonlinear handling region.

9. The computing system of claim 8, wherein the processor is configured to execute instructions to:
periodically receive a priori handling limit estimate for tire road friction from a vehicle capabilities node.

10. The computing system of claim 9, wherein the processor is configured to execute instructions to:
for no detected observable tire force and tire slip signals, apply the a priori handling limit estimate for tire road friction during a linear handling region.

11. The computing system of claim 10, wherein the processor is configured to execute instructions to:
receive a feedback signal from an electronic control unit (ECU) including an anti-lock braking system (ABS) signal, a traction control system (TCS) signal, or an electronic stability control (ESC) to indicate a limit friction event for the nonlinear handling region.

12. (canceled)

13. The computing system of claim 8, wherein the processor is configured to execute instructions to:
determine current driving conditions for the vehicle in the nonlinear handling region.

14. The computing system of claim 13, wherein the processor is configured to execute instructions to:
modifying driving behavior of the vehicle to safely control the vehicle during the limit friction event in the nonlinear handling region with the tire road limit nearness estimation being applied for modifying the driving behavior.

15. (canceled)

16. (canceled)

17. (canceled)

18. (canceled)

19. (canceled)

20. (canceled)

21. A computer implemented method comprising:
receiving a feedback signal from an electronic control unit (ECU) of an autonomous vehicle (AV);
determining whether tire force and tire slip signals of the AV are detected to indicate a limit friction event for a nonlinear handling region; and
determining real-time handling limit estimation including a tire road limit nearness estimation for the AV based partially on the feedback signal when the tire force and tire slip signals are detected for a nonlinear handling region.

22. The computer implemented method of claim 21, further comprising:
receiving an expected state of an autonomous vehicle (AV);
determining an actual state and disturbance estimation of the AV based on the expected state of the AV and the feedback signal; and
determining a road grade angle and road bank estimation.

23. The computer implemented method of claim 22, further comprising:
providing the actual state and the real-time handling limit estimation for tire road friction during the nonlinear handling region to a vehicle capabilities node.

24. The computer implemented method of claim 23, further comprising:
mapping, with the vehicle capabilities node, the real-time handling limit estimation to constraints for acceleration, velocity, or curvature; and
performing constraint management based on the real-time handling limit estimation.

25. The computer implemented method of claim 24, further comprising:
providing proactive environmental condition management based on receiving an environmental condition signal from on-vehicle detection sensors.

26. The computer implemented method of claim 21, further comprising:
modifying model parameters including tire parameters based on the actual state and the real-time handling limit estimation for tire road friction.

27. The computer implemented method of claim 21, wherein the feedback signal includes an anti-lock braking system (ABS) signal, a traction control system (TCS) signal, or an electronic stability control (ESC) to indicate a limit friction event for the nonlinear handling region.

28-40. (canceled)
